(19) United States
(12) Patent Application Publication
(10) Pub. No.: US 2026/0287810 A1
(43) Pub. Date: Sep. 24, 2026

(54) LINEAR LIGHT-EMITTING ELEMENT, LAMP ASSEMBLY AND MOTOR VEHICLE

(71) Applicant: VALEO VISION, Bobigny (FR)

(72) Inventors: Junlun DONG, foshan (CN); Wenqing CHEN, Foshan (CN); Changqi WU, Foshan (CN); Yinfeng CHENG, Foshan (CN); Zhenwen WEN, Foshan (CN)

(73) Assignee: VALEO VISION, Bobigny (FR)

(21) Appl. No.: 19/473,359

(22) PCT Filed: Apr. 5, 2024
(86) PCT No.: PCT/EP2024/059405

§ 371 Date: Oct. 7, 2025

(30) Foreign Application Priority Data
Apr. 7, 2023 (CN) 202310368927.X
Nov. 24, 2023 (CN) 202311578807.9

(51) Int. Cl. F21V 8/00; F21S 43/237

(52) U.S. Cl. CPC G02B 6/001; F21S 43/237

(57) ABSTRACT

A linear light-emitting element, having a lateral light exit region and including a core layer which is rod-shaped, at least one end face of the core layer receiving and allowing the entry of light from a light source, a cladding layer which envelops an outer peripheral surface of the core layer, the cladding layer having a smaller refractive index than that of the core layer, and light from the core layer entering the cladding layer by refraction, a transparent light exit layer which envelops an outer peripheral surface of the cladding layer, the transparent light exit layer transmitting light from the cladding layer, and a reflective layer which at least partially covers an outer peripheral surface of the transparent light exit layer, the reflective layer being at least partially opposite a lateral light exit region, reflecting light from the transparent light exit layer towards the lateral light exit region.

### TECHNICAL FIELD

Embodiments of the present invention relate generally to the field of lighting and/or signaling, in particular to a linear light-emitting element, a lamp assembly and a motor vehicle.

### BACKGROUND OF THE INVENTION

Linear light-emitting elements such as optical fibers are often used in motor vehicles to provide specific lighting and/or signaling functions or decorative functions. For example, they are used as ambient lights in the cabin to enhance ambience. Linear light-emitting elements in the prior art generally consist of a core layer and a cladding layer which envelops the outside of the core layer. The cladding layer contains scattering elements, which enable light entering the core layer from an end face of the linear light-emitting element to emerge from the entire outer peripheral surface of the linear light-emitting element. Thus, linear light-emitting elements in the prior art emit light throughout a 360-degree range. This type of linear light-emitting element has the problem of low brightness.

### SUMMARY OF THE INVENTION

An objective of the present invention is to solve or overcome at least one of the above and other problems and shortcomings in the prior art.

According to one aspect of the present invention, a linear light-emitting element is provided, having a lateral light exit region and comprising: a core layer which is rod-shaped, at least one end face of the core layer being configured to receive and allow the entry of light from a light source; a cladding layer which envelops an outer peripheral surface of the core layer, the cladding layer having a smaller refractive index than that of the core layer, and light from the core layer entering the cladding layer by refraction; a transparent light exit layer which envelops an outer peripheral surface of the cladding layer, the transparent light exit layer being configured to transmit light from the cladding layer; and a reflective layer which at least partially covers an outer peripheral surface of the transparent light exit layer, the reflective layer being configured to be at least partially opposite a lateral light exit region, so as to reflect light from the transparent light exit layer towards the lateral light exit region.

In some embodiments, the reflective layer is configured to cover at least half of the area of the outer peripheral surface of the cladding layer.

In some embodiments, materials of the transparent light exit layer and the reflective layer are chosen such that adhesion between the transparent light exit layer and the cladding layer is stronger than adhesion between the reflective layer and the cladding layer.

In some embodiments, the cladding layer is formed of a fluorine-containing material, and the transparent light exit layer is formed of a material containing no fluorine.

In some embodiments, the outer surface of the transparent light exit layer is configured as a flat surface or a curved surface.

In some embodiments, the transparent light exit layer comprises a scattering element to scatter light.

In some embodiments, the lateral light exit region comprises at least a portion of the outer peripheral surface of the transparent light exit layer.

In some embodiments, a fixing means for fixing the linear light-emitting element to a mounting member is formed on the reflective layer.

In some embodiments, the fixing means comprises an engagement part, configured to form a snap-fit connection with the mounting member.

In some embodiments, the engagement part comprises an elastic engagement head, the elastic engagement head extending away from the reflective layer and having an arrow-shaped cross section, and being configured to cooperate with a through-slot of the mounting member.

In some embodiments, a hollow part is formed on the elastic engagement head to facilitate elastic deformation.

In some embodiments, the engagement part comprises an engagement face, which comprises at least a portion of an outer surface of the reflective layer and is configured to abut an elastic snap-fit connector on the mounting member.

In some embodiments, the fixing means comprises a through-hole, configured to form a threaded connection with the mounting member by means of a bolt.

In some embodiments, an extension part is formed on the reflective layer, the extension part extending substantially in a direction opposite to a direction of lateral light emergence of the linear light-emitting element, and the through-hole being formed in the extension part.

In some embodiments, two wing parts with opposite directions of extension are formed on the reflective layer, the two wing parts both extending transversely to a direction of lateral light emergence of the linear light-emitting element, and the through-hole being formed in the two wing parts.

In some embodiments, a chamfer is formed at a junction of the wing part with the reflective layer.

In some embodiments, the fixing means comprises a bonding part, configured to form an adhesive connection with the mounting member.

In some embodiments, the linear light-emitting element further comprises an outer lens formed as a single piece with the transparent light exit layer, the lateral light exit region comprising at least a portion of an outer surface of the outer lens.

In some embodiments, a fixing means for fixing the linear light-emitting element to the mounting member is further formed on the single piece consisting of the outer lens and the transparent light exit layer.

In some embodiments, the fixing means comprises at least one of an engagement part for forming a snap-fit connection with the mounting member, a through-hole forming a threaded connection, and a bonding part forming an adhesive connection.

In some embodiments, the linear light-emitting element comprises a flexible optical fiber which emits light laterally.

In some embodiments, a base material of the core layer comprises an acrylic block copolymer and/or polymethyl methacrylate.

In some embodiments, a base material of the cladding layer comprises a fluoropolymer.

In some embodiments, the fluoropolymer comprises fluorinated ethylene propylene copolymer and/or polyvinylidene difluoride.

In some embodiments, the cladding layer comprises an ultraviolet absorbing material;

the cladding layer comprises a light diffusing material.

In some embodiments, a base material of the transparent light exit layer comprises a flexible thermoplastic transparent resin.

In some embodiments, the flexible thermoplastic transparent resin has a hardness lower than A100;
the flexible thermoplastic transparent resin comprises a flexible thermoplastic acrylic resin.

In some embodiments, the transparent light exit layer comprises an antioxidant material;

the transparent light exit layer comprises an ultraviolet absorbing material.

In some embodiments, a base material of the reflective layer comprises a flexible thermoplastic transparent resin.

In some embodiments, the flexible thermoplastic transparent resin has a hardness lower than A100;
the flexible thermoplastic transparent resin comprises a flexible thermoplastic acrylic resin.

In some embodiments, a base material of the reflective layer and a base material of the transparent light exit layer are the same.

In some embodiments, the reflective layer comprises an antioxidant material;
the reflective layer comprises an ultraviolet absorbing material;
the reflective layer comprises a color powder and/or color masterbatch.

In some embodiments, the ultraviolet absorbing material comprises at least one of low-volatile dimeric 2-hydroxybenzotriazole and hydroxyphenylbenzotriazole.

According to another aspect of the present invention, embodiments further provide a lamp assembly, comprising any one of the linear light-emitting elements described above, and a light source which emits light towards at least one end face of the linear light-emitting element.

In some embodiments, the lamp assembly further comprises a mounting member for mounting and fixing the linear light-emitting element, a connection between the mounting member and the linear light-emitting element comprising at least one of the following: a snap-fit connection, a threaded connection and an adhesive connection.

According to another aspect of the present invention, embodiments further provide a vehicle comprising the lamp assembly described above.

Other objectives and advantages of the present invention will become obvious through the following detailed description of the invention with reference to the drawings, which can also aid comprehensive understanding of the invention.

### BRIEF DESCRIPTION OF THE DRAWINGS

These and/or other aspects, features and advantages of the present invention will become obvious and easy to understand through the following description of illustrative embodiments in conjunction with the accompanying drawings, wherein:

FIG. 1 shows schematically a perspective drawing of a linear light-emitting element 100 according to the present invention.

FIG. 2 shows schematically a schematic drawing of a cross section of the linear light-emitting element 100 in FIG. 1, taken along the line F-F.

FIG. 3 shows schematically a perspective drawing of a lamp assembly according to a first embodiment of the present invention.

FIG. 4 shows schematically a schematic drawing of a cross section of the lamp assembly in FIG. 3, taken along the line G-G.

FIG. 5 shows schematically a perspective drawing of a lamp assembly according to a second embodiment of the present invention.

FIG. 6 shows schematically a schematic drawing of a cross section of the lamp assembly in FIG. 5, taken along the line H-H.

FIG. 7 shows schematically a perspective drawing of a lamp assembly according to a third embodiment of the present invention.

FIG. 8 shows schematically a schematic drawing of a cross section of the lamp assembly in FIG. 7, taken along the line I-I.

FIG. 9 shows schematically a schematic drawing of a cross section of a variant embodiment of the lamp assembly according to the third embodiment of the present invention in FIGS. 7 and 8.

FIG. 10 shows schematically a perspective drawing of a lamp assembly according to a fourth embodiment of the present invention.

FIG. 11 shows schematically a schematic drawing of a cross section of the lamp assembly in FIG. 10, taken along the line J-J.

FIG. 12 shows schematically a perspective drawing of a lamp assembly according to a fifth embodiment of the present invention.

FIG. 13 shows schematically a schematic drawing of a cross section of the lamp assembly in FIG. 12, taken along the line K-K.

### DETAILED DESCRIPTION OF THE INVENTION

Embodiments of the present invention will be described in detail below in conjunction with the accompanying drawings. Herein, identical or similar components are indicated by identical or similar reference numerals. The following explanation of embodiments of the present invention with reference to the accompanying drawings is intended to explain the overall disclosed concept of the present invention, and should not be interpreted as a limitation of the present invention.

In addition, in the following detailed description, for ease of explanation, many specific details are expounded to provide a comprehensive understanding of the embodiments of the present invention. However, it is obvious that one or more embodiments may also be implemented without these specific details. In other scenarios, well-known structures and devices are shown in the form of illustrations to simplify the drawings.

FIG. 1 shows schematically a perspective drawing of a linear light-emitting element 100 according to the present invention.

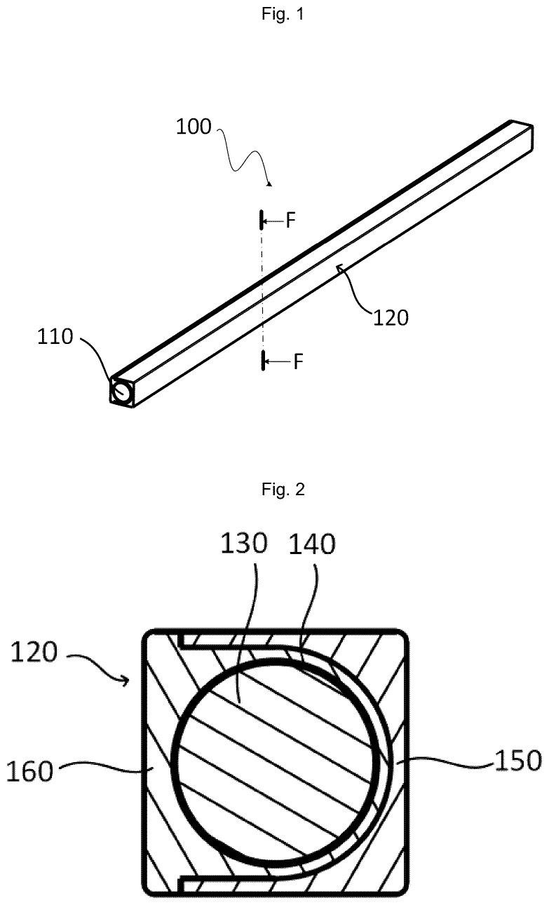

FIG. 2 shows schematically a schematic drawing of a cross section of the linear light-emitting element 100 in FIG. 1, taken along the line F-F. As shown in the figures, the linear light-emitting element 100 comprises two end faces 110, wherein at least one end face 110 is configured to receive and allow the entry of light from a light source (not shown); and a lateral light exit region 120, wherein light entering the interior of the linear light-emitting element 100 emerges from the lateral light exit region 12. That is to say, the linear light-emitting element 100 is an element which emits light laterally. More specifically, the linear light-emitting element 100 further comprises a core layer 130, which is rod-shaped and made of a transparent material. Light from the light source enters the core layer 130 through the end face 110, and can propagate by total reflection inside the core layer 130 towards the other end face in the longitudinal direction of the linear light-emitting element 100. Furthermore, in this embodiment the core layer 130 has a circular cross-sectional shape, but the core layer 130 could also have an oval, polygonal, irregular, or any other suitable cross-sectional shape. A cladding layer 140 envelops an outer peripheral surface of the core layer 130, i.e. completely covers the outer peripheral surface of the core layer 130. The cladding layer 140 may be made of a transparent material and has a smaller refractive index than that of the core layer 130. Some of the light from the core layer 130 may enter the cladding layer 140 by refraction; for example, the cladding layer 140 may be formed of a scattering material, or light extracting elements (for example but not limited to optical protrusions, optical depressions, optical grain, saw teeth, etc.) are constructed on the cladding layer 140, causing the conditions for total reflection of some of the light in the core layer 130 to be broken, such that this light enters the cladding layer 140.

It must be explained that in the present invention, “transparent material” means a material capable of transmitting light; this may be completely transparent or semi-transparent, or may have another transmittance percentage or haze value. This is not specifically defined here.

In an embodiment of the present invention, the linear light-emitting element 100 further comprises a reflective layer 150 and a transparent light exit layer 160, wherein the transparent light exit layer 160 envelops an outer peripheral surface of the cladding layer 140, i.e. completely covers the outer peripheral surface of the cladding layer 140. The transparent light exit layer 160 is formed of a transparent material, and is configured to transmit light from the cladding layer 140. In the example shown in FIG. 2, the lateral light exit region 120 comprises at least a portion of an outer peripheral surface of the transparent light exit layer 160. The reflective layer 150 at least partially covers the outer peripheral surface of the transparent light exit layer 160, and is thus isolated from the cladding layer 140, i.e. not in contact with the cladding layer 140. The reflective layer 150 contains an opaque material, and is configured to be at least partially opposite the lateral light exit region 120, so as to reflect light from the transparent light exit layer 160 towards the lateral light exit region 120. The reflected light will pass through the transparent light exit layer 160, the cladding layer 140 and the core layer 130 again and thus reach the lateral light exit region 120.

In an embodiment of the present invention, as a result of providing the reflective layer containing the opaque material outside the cladding layer, the linear light-emitting element no longer emits light throughout a 360-degree range, and instead emits light only in a required partial region (the lateral light exit region), thereby reducing light leakage and increasing optical efficiency. The overall brightness of the linear light-emitting element is increased, being able to meet requirements even at minimum brightness.

In an embodiment of the present invention, the transparent light exit layer that covers the cladding layer can protect the cladding layer, preventing the cladding layer from being scratched, and thus avoiding undesirable bright spots caused by scratches on the cladding layer. In addition, the transparent light exit layer can also increase the abrasion resistance of the linear light-emitting element.

In an embodiment of the present invention, if the reflective layer covers a portion of the outer peripheral surface of the cladding layer, in the case where there is poor adhesion between the material of the cladding layer and the material of the reflective layer, for example but without limitation, in the case where the cladding layer is formed of a fluorine-containing material, an air gap will appear between the cladding layer and the reflective layer, and since the cladding layer is transparent and the reflective layer is opaque, the air gap will be very conspicuous, severely impacting appearance. For this reason, in an embodiment of the present invention, the cladding layer is enveloped by the transparent light exit layer; thus, even if an air gap appears, the air gap will not be easily noticeable, because the two layers are both transparent.

Preferably, the materials of the transparent light exit layer 160 and the reflective layer 150 are chosen such that the adhesion between the transparent light exit layer 160 and the cladding layer 140 is stronger than the adhesion between the reflective layer 150 and the cladding layer 140. In a non-limiting example, the cladding layer 140 is formed of a fluorine-containing material, and the transparent light exit layer 160 is formed of a material containing no fluorine.

Preferably, in order to cause more light to emerge through the lateral light exit region 120, the reflective layer 150 is configured to cover at least half of the area of the outer peripheral surface of the transparent light exit layer 160.

Preferably, the transparent light exit layer 160 may comprise scattering elements to scatter light from the cladding layer or reflective layer, and increase the uniformity of the illumination effect; for example but without limitation, the transparent light exit layer 160 may be made of a scattering material, or scattering units such as optical protrusions, optical depressions, optical grain and the like may be formed on an inner surface and/or an outer surface of the transparent light exit layer. Furthermore, as shown in the figures, the transparent light exit layer 160 has a flat outer surface, so as to meet the styling requirement for a planar appearance, but the transparent light exit layer 160 could of course also have a curved type of outer surface, according to other styling requirements.

Preferably, the layers of the linear light-emitting element 100 are formed by a co-extrusion process, so as to reduce costs and simplify the process.

Preferably, a base material of the core layer 130 comprises an acrylic block copolymer (MAM) and/or polymethyl methacrylate (PMMA).

Preferably, a base material of the cladding layer 140 comprises a fluoropolymer. The fluoropolymer comprises, for example, fluorinated ethylene propylene (FEP) copolymer and/or polyvinylidene difluoride (PVDF). The cladding layer 140 may further comprise some additives, for example: the cladding layer 140 comprises an ultraviolet absorbing material; the cladding layer 140 comprises a light diffusing material, which has the effect of diffusing light.

Preferably, a base material of the transparent light exit layer 160 comprises a flexible thermoplastic transparent resin. The hardness of the flexible thermoplastic transparent resin is preferably less than A100; and the flexible thermoplastic transparent resin for example comprises a flexible thermoplastic acrylic resin. The transparent light exit layer 160 may further comprise some additives, for example: the transparent light exit layer 160 comprises an antioxidant material, which has the effect of preventing oxidation of the base material; the transparent light exit layer 160 comprises an ultraviolet absorbing material.

Preferably, a base material of the reflective layer 150 comprises a flexible thermoplastic transparent resin. The hardness of the flexible thermoplastic transparent resin is preferably less than A 100; and the flexible thermoplastic transparent resin for example comprises a flexible thermoplastic acrylic resin. Moreover, the base material of the reflective layer 150 and the base material of the transparent light exit layer 160 are preferably the same, so as to ensure good adhesion between the reflective layer 150 and the transparent light exit layer 160. The reflective layer 150 may further comprise some additives, for example: the reflective layer 150 comprises an antioxidant material; the reflective layer 150 comprises an ultraviolet absorbing material; the reflective layer 150 comprises a color powder and/or color masterbatch. Color powder and/or color masterbatch can modify the base material of the reflective layer 150, and thereby increase the reflectivity.

In the embodiment above, the ultraviolet absorbing material can absorb ultraviolet rays, giving the linear light-emitting element 100 ultraviolet-resistant functionality, preventing yellowing of the linear light-emitting element 100 when irradiated by ultraviolet rays, and can thus extend the life and quality of use of the linear light-emitting element 100. In addition, compared with adding an ultraviolet absorbing material to the cladding layer 140, when an ultraviolet absorbing material is added to the transparent light exit layer 160, since the transparent light exit layer 160 has a greater thickness than the cladding layer 140 and is located at the outermost part of the linear light-emitting element 100 as a whole, adding an ultraviolet absorbing material to the transparent light exit layer 160 can make the manufacturing process easier without adding extra costs, and also increases the ultraviolet resistance of the linear light-emitting element 100.

The ultraviolet absorbing material for example comprises at least one of low-volatile dimeric 2-hydroxybenzotriazole and hydroxyphenylbenzotriazole, but the present application is not limited to this.

A lamp assembly comprising the linear light-emitting element 100 described above is presented below by means of embodiments.

A lamp assembly according to an embodiment of the present invention comprises a linear light-emitting element 100 and a light source (not shown), wherein, as stated above, the linear light-emitting element 100 is rod-shaped and of a laterally light-emitting type; light from the light source enters the interior of the linear light-emitting element 100 through at least one end face of the linear light-emitting element 100, and emerges from at least a portion of an outer peripheral surface of the linear light-emitting element 100. Optionally, the lamp assembly may further comprise a mounting member 200, wherein the mounting member 200 is used for mounting and fixing the linear light-emitting element 100, and may be further embedded in another structure to form a complete and smooth appearance. The lamp assembly according to an embodiment of the present invention may provide a light function of any suitable type, for example but without limitation, a lighting function, a signaling function, a decorative function, and so on.

### 1. First Embodiment of Lamp Assembly

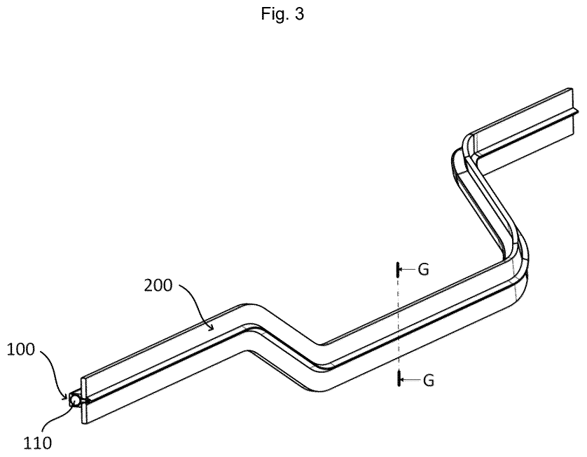

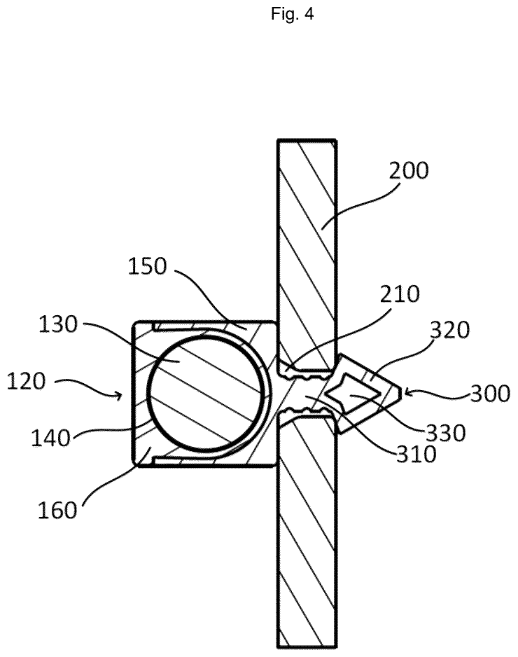

FIG. 3 shows schematically a perspective drawing of a lamp assembly according to a first embodiment of the present invention; FIG. 4 shows schematically a schematic drawing of a cross section of the lamp assembly in FIG. 3, taken along the line G-G. As shown in FIGS. 3 and 4, a fixing means for fixing the linear light-emitting element 100 to the mounting member 200 is also formed on the reflective layer 150 of the linear light-emitting element 100, the fixing means comprising an engagement part configured to form a snap-fit connection with the mounting member 200. Specifically, the engagement part comprises an elastic engagement head 300, which is made of an elastic material and extends away from the reflective layer 150 substantially in a direction opposite to a direction of lateral light emergence of the linear light-emitting element 100. The elastic engagement head 300 and the reflective layer 150 may be of the same material or different materials, and for example but without limitation, are formed as a single piece by a co-extrusion process or an injection molding process, etc. The elastic engagement head 300 has an arrow-shaped cross section; a part joined to the reflective layer 150 is a shank part 310, and a part joined to the shank part 310 is a deformation part 320. Correspondingly, the mounting member 200 comprises a through-slot 210; when the linear light-emitting element 100 is mounted, the elastic engagement head 300 passes through the through-slot 210, and in this process the deformation part 320 experiences elastic deformation. After passing through the through-slot 210, the deformation part 320 recovers from the deformation and abuts a surface near the through-slot 210, to prevent disengagement.

Preferably, a hollow part 330 is formed on the deformation part 320 of the elastic engagement head 300, to enable the deformation part 320 to deform more easily in the process of passing through the through-slot 210.

In an embodiment of the present invention, the fixing means is formed on the reflective layer, and does not act directly on the core layer or the cladding layer; this can prevent abnormal bright spots caused by pressure on the core layer or cladding layer, and can also improve the appearance of the linear light-emitting element.

### 2. Second Embodiment of Lamp Assembly

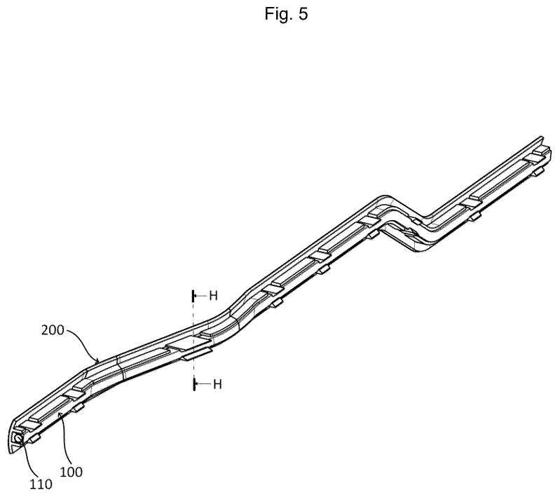

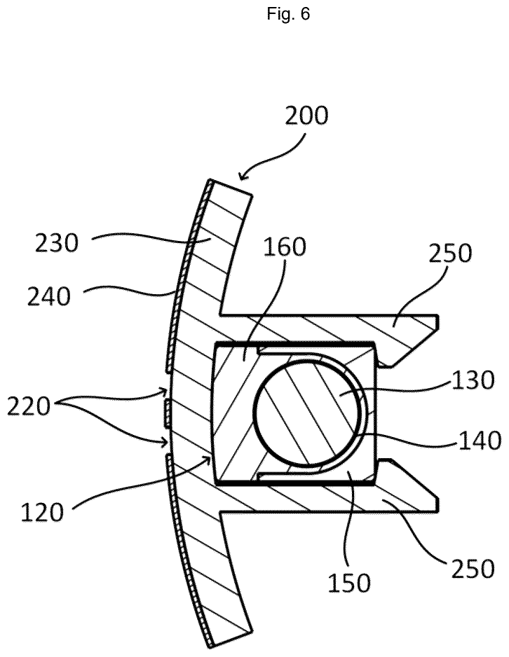

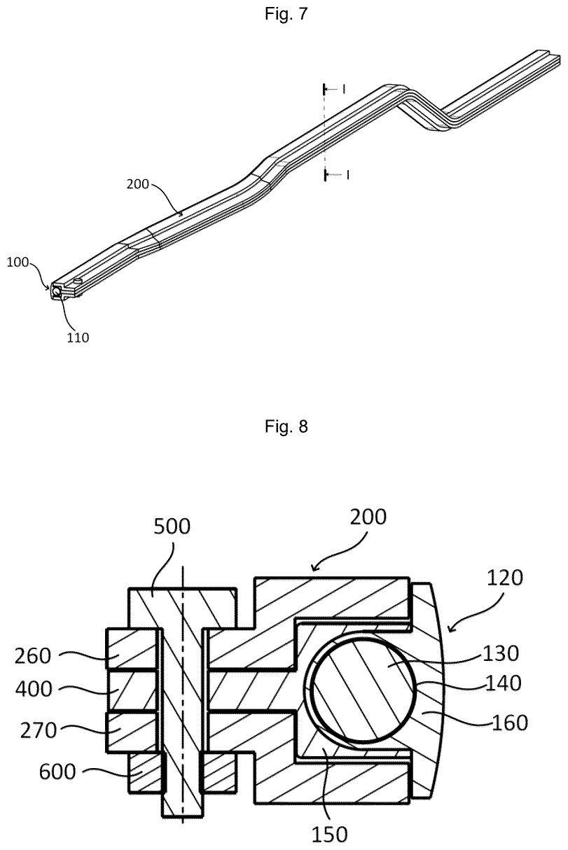

FIG. 5 shows schematically a perspective drawing of a lamp assembly according to a second embodiment of the present invention; FIG. 6 shows schematically a schematic drawing of a cross section of the lamp assembly in FIG. 5, taken along the line H-H. As shown in FIGS. 5 and 6, the mounting member 200 comprises a light-permeable part 230 and a light-impermeable part 240, wherein the light-impermeable part 240 covers the outside of the light-permeable part 230 in such a way as to leave light-transmitting windows 220, such that light from the lateral light exit region 120 of the linear light-emitting element 100 can emerge through the light-transmitting windows 220. The light-impermeable part 240 may be a paint layer, a film sheet, a printed layer, a screen-printed layer, an injection-molded layer, etc. As shown in the figures, two elastic snap-fit connectors 250 arranged opposite each other are formed integrally on a rear side of the light-permeable part 230. A space capable of accommodating the linear light-emitting element 100 is formed between the two elastic snap-fit connectors 250; as the linear light-emitting element 100 is being mounted, the linear light-emitting element 100 causes the elastic snap-fit connectors 250 to experience elastic deformation, and when the linear light-emitting element 100 has completely entered the accommodating space between the two snap-fit connectors, the elastic snap-fit connectors 250 recover from the deformation and abut an outer surface of the reflective layer 150, to prevent disengagement. That is to say, in this embodiment, the fixing means for fixing the linear light-emitting element 100 to the mounting member 200 comprises an engagement part, which is configured to form a snap-fit connection with the mounting member 200. The engagement part comprises an engagement face, which comprises at least a portion of the outer surface of the reflective layer 150, and is configured to abut the elastic snap-fit connectors 250 on the mounting member 200.

Furthermore, in addition to the elastic snap-fit connectors 250, at least one recess for accommodating the linear light-emitting element may also be formed on the rear side of the light-permeable part 230, the shape of the recess matching the shape of the linear light-emitting element.

It will be understood that the structure of the mounting member in this embodiment is not limited to this. For example, the light-permeable part 230 may be replaced with a light-impermeable part; the elastic snap-fit connectors 250 and the recess may be formed on the light-impermeable part, and a light-permeable part is formed integrally on the light-impermeable part, for example by an injection molding or co-extrusion process, etc., the light-permeable part forming the light-permeable window 220.

In an embodiment of the present invention, the fixing means is formed on the reflective layer, and does not act directly on the core layer or the cladding layer; this can prevent abnormal bright spots caused by pressure on the core layer or cladding layer, and can also improve the appearance of the linear light-emitting element.

### 3. Third Embodiment

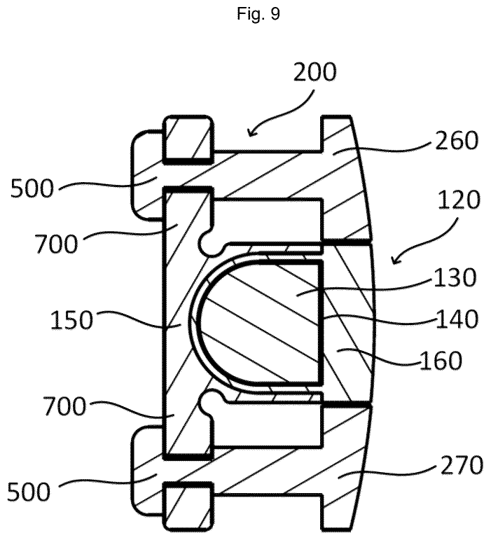

FIG. 7 shows schematically a perspective drawing of a lamp assembly according to a third embodiment of the present invention; FIG. 8 shows schematically a schematic drawing of a cross section of the lamp assembly in FIG. 7, taken along the line I-I. As shown in FIGS. 7 and 8, an extension part 400 is formed on the reflective layer 150 of the linear light-emitting element 100, the extension part 400 extending away from the reflective layer 150 substantially in a direction opposite to the direction of lateral light emergence of the linear light-emitting element 100. The extension part 400 and the reflective layer 150 may be of the same material or different materials, and for example but without limitation, are formed as a single piece by a co-extrusion process or an injection molding process, etc., and a through-hole is formed in the extension part 400. The mounting member 200 comprises an upper mounting part 260 and a lower mounting part 270 arranged opposite each other, which may be made of an opaque material, and which both have a through-hole formed therein. During mounting of the linear light-emitting element 100, the linear light-emitting element 100 is inserted between the upper mounting part 260 and the lower mounting part 270, i.e. the three components form a sandwich structure, with their respective through-holes aligned with each other, and a bolt 500 is passed through the through-holes of the three components transversely to the direction of lateral light emergence of the linear light-emitting element 100, and connected to a nut 600 by screw-threads. That is to say, in this embodiment, the fixing means for fixing the linear light-emitting element 100 to the mounting member 200 comprises the through-hole formed in the extension part 400, and is configured to form a threaded connection with the mounting member 200 by means of a bolt.

Furthermore, as shown in the figures, in this embodiment, the transparent light exit layer 160 has a T-shaped cross section, continuing to extend outwards, upwards and downwards in the direction of light emergence from the space between the upper mounting part 260 and the lower mounting part 270, and finally covering the outside of the upper mounting part 260 and lower mounting part 270, such that no transparent part is needed on the mounting member 200.

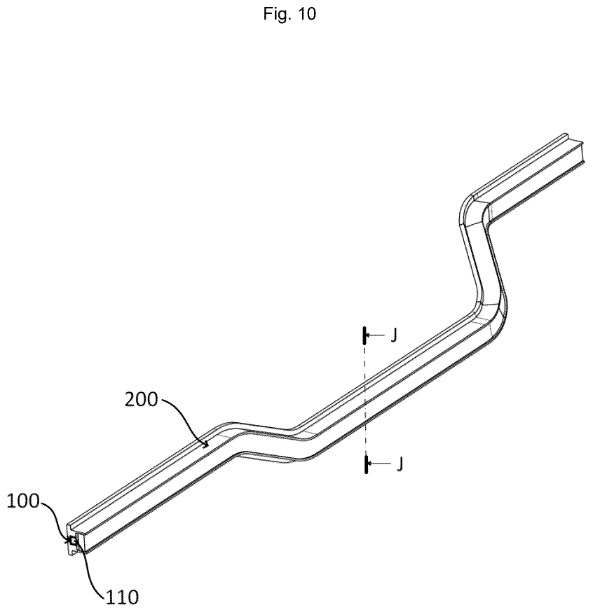

FIG. 9 shows schematically a schematic drawing of a cross section of a variant embodiment of the lamp assembly according to the third embodiment of the present invention. As shown in FIG. 9, in this variant embodiment, the core layer 130 has a D-shaped cross section, i.e. has a planar part on a side close to the lateral light exit region, and correspondingly, an inner surface and an outer surface of the transparent light exit layer 160 are both relatively flat, so as to meet a styling requirement for a planar appearance. Two wing parts 700 with opposite directions of extension are formed on the reflective layer 150, the two wing parts 700 both extending transversely to the direction of lateral light emergence of the linear light-emitting element 100.

The wing part 700 and the reflective layer 150 may be of the same material or different materials, and for example but without limitation, are formed as a single piece by a co-extrusion process or an injection molding process, etc., and a through-hole is formed in each wing part 700. The mounting member 200 comprises an upper mounting part 260 and a lower mounting part 270 arranged opposite each other, which may be made of an opaque material, and which both have a threaded hole formed therein. In addition, the transparent light exit layer 160 is completely embedded between the upper mounting part 260 and the lower mounting part 270, such that no transparent part is needed on the mounting member 2. During mounting of the linear light-emitting element 100, the linear light-emitting element 100 is inserted between the upper mounting part 260 and the lower mounting part 270, and the through-holes in the two wing parts 700 are aligned with the threaded holes in the upper mounting part 260 and lower mounting part 270; two bolts 500 are passed through the through-holes substantially in the direction of lateral light emergence of the linear light-emitting element 100, and finally screwed into the threaded holes of the upper mounting part 260 and lower mounting part 270 respectively. That is to say, in this embodiment, the fixing means for fixing the linear light-emitting element 100 to the mounting member 200 comprises the through-holes formed in the wing parts 700, and is configured to form a threaded connection with the mounting member 200 by means of bolts.

Preferably, as shown in the figures, a chamfer is formed at a junction of the wing part 700 with the reflective layer 150, to prevent stress concentration here.

In an embodiment of the present invention, the fixing means is formed on the reflective layer, and does not act directly on the core layer or the cladding layer; this can prevent abnormal bright spots caused by pressure on the core layer or cladding layer, and can also improve the appearance of the linear light-emitting element.

### 4. Fourth Embodiment

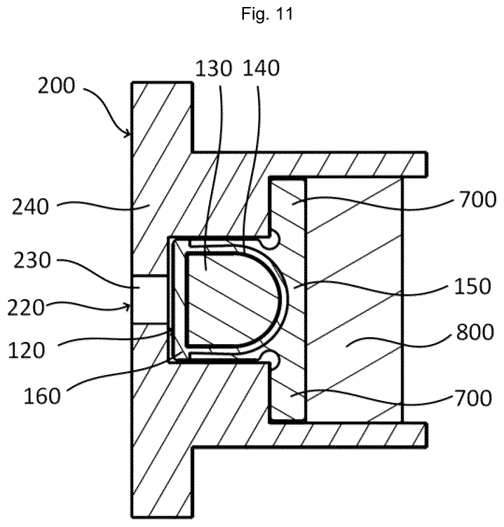

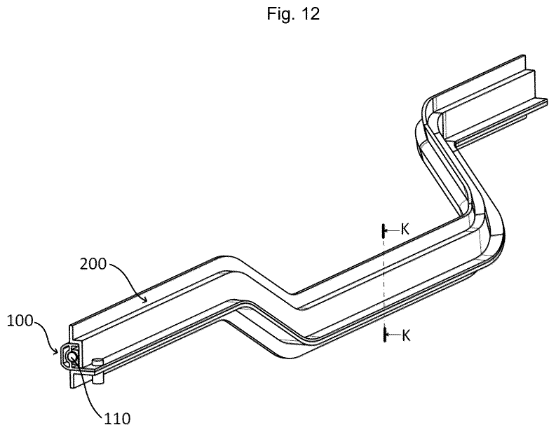

FIG. 10 shows schematically a perspective drawing of a lamp assembly according to a fourth embodiment of the present invention; FIG. 11 shows schematically a schematic drawing of a cross section of the lamp assembly in FIG. 10, taken along the line J-J.

As shown in FIGS. 10 and 11, two wing parts 700 with opposite directions of extension are likewise formed on the reflective layer 150, the two wing parts 700 both extending transversely to the direction of lateral light emergence of the linear light-emitting element 100. The wing part 700 and the reflective layer 150 may be of the same material or different materials, and for example but without limitation, are formed as a single piece by a co-extrusion process or an injection molding process, etc. Preferably, a chamfer is formed at a junction of the wing part 700 with the reflective layer 150, to prevent stress concentration here. The mounting member 200 comprises a light-permeable part 230 and a light-impermeable part 240, which are integrally formed by a co-extrusion process, an injection molding process or another process, such that the light-permeable part 230 is embedded in the light-impermeable part 240 to form a light-transmitting window 220. A T-shaped recess matched to the shape of the linear light-emitting element 100 is formed in the light-impermeable part 240; during mounting of the linear light-emitting element 100, it can be placed in the T-shaped recess such that the lateral light exit region 120 is opposite the light-transmitting window 220, and the reflective layer 150 and wing parts 700 may be bonded to a rubber body 800. The rubber body 800 is simultaneously bonded to inner walls of the T-shaped recess, thereby fixing the linear light-emitting element 100. In this embodiment, the wing parts 700 can increase the bonding area, but it will be understood that it is also possible for no wing parts 700 to be formed on the reflective layer 150, with an outer surface of the reflective layer 150 being used as a bonding face.

That is to say, in this embodiment, the fixing means for fixing the linear light-emitting element 100 to the mounting member 200 comprises a bonding part formed on the reflective layer 150, the bonding part being configured to form an adhesive connection with the mounting member, wherein the bonding part may comprise the outer surface of the reflective layer 150.

In addition, it will be understood that the structure of the mounting member 200 is not limited to this, and could also be the structure of the second embodiment in FIG. 6, which is not described again here.

In an embodiment of the present invention, the fixing means is formed on the reflective layer, and does not act directly on the core layer or the cladding layer; this can prevent abnormal bright spots caused by pressure on the core layer or cladding layer, and can also improve the appearance of the linear light-emitting element.

### 5. Fifth Embodiment

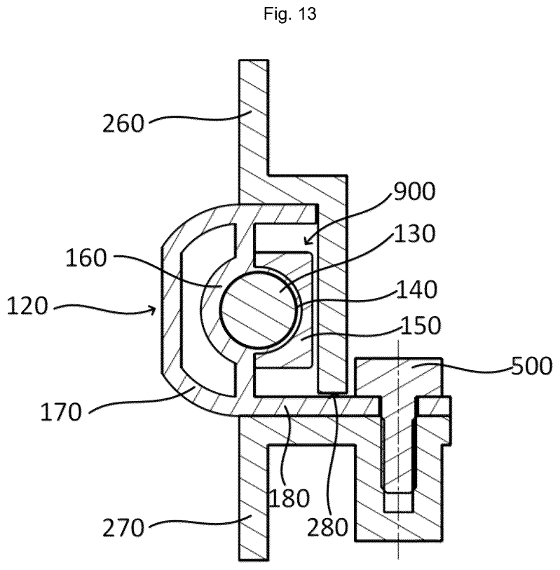

FIG. 12 shows schematically a perspective drawing of a lamp assembly according to a fifth embodiment of the present invention; FIG. 13 shows schematically a schematic drawing of a cross section of the lamp assembly in FIG. 12, taken along the line K-K.

As shown in FIGS. 12 and 13, the linear light-emitting element 100 further comprises an outer lens 170, which is located outside the transparent light exit layer 160 in the direction of lateral light emergence; in this case, the lateral light exit region 120 comprises at least a portion of an outer surface of the outer lens 170. The outer lens 170 and the transparent light exit layer 160 are integrally formed of the same material or different materials, for example but without limitation, by an injection molding process or a co-extrusion process, etc. The mounting member 200 comprises an upper mounting member 260 and a lower mounting member 270, both of which may be made of an opaque material and enclose a recessed space 900. During mounting of the linear light-emitting element 100, the linear light-emitting element 100 may be placed in the recessed space 900, and the outer lens 170 protrudes outwards from the recessed space 900, but could of course also be completely accommodated in the recessed space 900. A fixing means for fixing the linear light-emitting element to the mounting member 200 is also formed on the single piece consisting of the transparent light exit layer 160 and the outer lens 170. The fixing means comprises a fixing plate 180, which extends from the transparent light exit layer 160 and the outer lens 170 towards a rear side substantially in a direction opposite to the direction of lateral light emergence, and has a through-hole formed therein. The fixing plate 180 may be formed integrally with the transparent light exit layer 160 and the outer lens 170, of the same or a different material. A gap 280 is left in the recessed space 900 of the mounting member 200, and the fixing plate 180 extends through the gap 280 and out of the recessed space 900. A threaded hole is formed in the lower mounting member 270, and aligned with the through-hole in the fixing plate 180. A bolt 500 is passed downwards through the through-hole in the fixing plate 180, transversely to the direction of lateral light emergence of the linear light-emitting element 100, and finally screwed into the threaded hole in the lower mounting member 270.

It will be understood that the fixing means formed on the single piece consisting of the transparent light exit layer 160 and the outer lens 170 is not limited to the through-hole used to form a threaded connection with the mounting member, and could also comprise an engagement part for forming a snap-fit connection with the mounting member, or a bonding part forming an adhesive connection, etc., as in the embodiments above. In addition, the fixing means formed on the single piece consisting of the transparent light exit layer 160 and the outer lens 170 could also be used in combination with the fixing means on the reflective layer 150 in the embodiments above.

In an embodiment of the present invention, having the outer lens formed integrally with the transparent light exit layer can better protect the linear light-emitting element and avoid the need to further form a light-permeable part on the mounting member, thus simplifying the process while also being able to reduce production costs. In addition, a fixing means may also be formed on the single piece consisting of the outer lens and the transparent light exit layer, thereby preventing abnormal bright spots caused by direct pressure on the core layer or cladding layer, while the appearance of the linear light-emitting element can also be improved.

Possible structures of the lamp assembly have been described above by means of different embodiments, but it will be understood that the embodiments of the present invention are not limited to this, and any possible obvious variants of the embodiments above shall still fall within the scope of protection of the present invention.

In an embodiment of the present invention, as a non-limiting embodiment, the linear light-emitting element may comprise a flexible optical fiber of a laterally light-emitting type, and may be bent at will according to requirements, but the present invention is not limited to this, and could also be a light-emitting element of any other suitable type.

Embodiments of the present invention further provide a vehicle comprising a lamp assembly as described in any of the embodiments above.

Although the present invention has been explained in conjunction with the drawings, the embodiments disclosed in the drawings are intended to provide an exemplary illustration of preferred embodiments of the present invention, and must not be interpreted as a limitation of the present invention. The dimensional proportions in the drawings are merely schematic, and must not be interpreted as a limitation of the present invention.

Although some embodiments of the overall concept of the present invention have been shown and explained, those skilled in the art will understand that changes may be made to these embodiments without departing from the principles and spirit of the overall disclosed concept.

The scope of the present invention is defined by the claims and their equivalents.

1. A linear light-emitting element, having a lateral light exit region, comprising:
a core layer which is rod-shaped, at least one end face of the core layer being configured to receive and allow the entry of light from a light source;
a cladding layer which envelops an outer peripheral surface of the core layer, the cladding layer having a smaller refractive index than that of the core layer, and light from the core layer entering the cladding layer by refraction;
a transparent light exit layer which envelops an outer peripheral surface of the cladding layer, the transparent light exit layer being configured to transmit light from the cladding layer; and
a reflective layer which at least partially covers an outer peripheral surface of the transparent light exit layer, the reflective layer being configured to be at least partially opposite a lateral light exit region, so as to reflect light from the transparent light exit layer towards the lateral light exit region.

2. The linear light-emitting element according to claim 1, wherein the reflective layer is configured to cover at least half of the area of the outer peripheral surface of the transparent light exit layer;
the lateral light exit region includes at least a portion of the outer peripheral surface of the transparent light exit layer; and
the linear light-emitting element includes a flexible optical fiber which emits light laterally.

3. The linear light-emitting element according to claim 1, wherein:
materials of the transparent light exit layer and the reflective layer are chosen such that adhesion between the transparent light exit layer and the cladding layer is stronger than adhesion between the reflective layer and the cladding layer; and
with the cladding layer being formed of a fluorine-containing material, and the transparent light exit layer being formed of a material containing no fluorine.

4. (canceled)

5. The linear light-emitting element according to claim 1, wherein the outer surface of the transparent light exit layer is configured as a flat surface or a curved surface; and
the transparent light exit layer includes a scattering element to scatter light.

6. (canceled)

7. (canceled)

8. The linear light-emitting element according to claim 1, wherein a fixing means for fixing the linear light-emitting element to a mounting member is formed on the reflective layer.

9. The linear light-emitting element according to claim 8, wherein the fixing means includes an engagement part, configured to form a snap-fit connection with the mounting member.

10. The linear light-emitting element according to claim 9, wherein the engagement part includes an elastic engagement head, the elastic engagement head extending away from the reflective layer and having an arrow-shaped cross section, and being configured to cooperate with a through-slot of the mounting member, and a hollow part is formed on the elastic engagement head to facilitate elastic deformation.

11. (canceled)

12. The linear light-emitting element according to claim 9, wherein the engagement part includes an engagement face, which includes at least a portion of an outer surface of the reflective layer and is configured to abut an elastic snap-fit connector on the mounting member.

13. The linear light-emitting element according to claim 8, wherein the fixing means includes a through-hole, configured to form a threaded connection with the mounting member by means of a bolt;
an extension part is formed on the reflective layer, the extension part extending substantially in a direction opposite to a direction of lateral light emergence of the linear light-emitting element, and the through-hole being formed in the extension part:
two wing parts with opposite directions of extension are formed on the reflective layer, the two wing parts both extending transversely to a direction of lateral light emergence of the linear light-emitting element. and the through-hole being formed in the two wing parts; and
a chamfer is formed at a junction of the wing part with the reflective layer.

14. (canceled)

15. (canceled)

16. (canceled)

17. The linear light-emitting element according to claim 8, wherein the fixing means includes a bonding part, configured to form an adhesive connection with the mounting member.

18. The linear light-emitting element according to claim 1, further comprising an outer lens formed as a single piece with the transparent light exit layer, the lateral light exit region INCLUDES at least a portion of an outer surface of the outer lens;
a fixing means for fixing the linear light-emitting element to the mounting member is further formed on the single piece consisting of the outer lens and the transparent light exit layer; and
the fixing means includes at least one of an engagement part for forming a snap-fit connection with the mounting member, a through-hole forming a threaded connection, and a bonding part forming an adhesive connection.

19. (canceled)

20. (canceled)

21. (canceled)

22. The linear light-emitting element according to claim 1, wherein a base material of the core layer includes an acrylic block copolymer and/or polymethyl methacrylate;
a base material of the cladding layer includes a fluoropolymer; and
the fluoropolymer includes fluorinated ethylene propylene copolymer and/or polyvinylidene difluoride.

23. (canceled)

24. (canceled)

25. The linear light-emitting element according to claim 1, wherein the cladding layer includes an ultraviolet absorbing material;
and a light diffusing material.

26. The linear light-emitting element according to claim 1, wherein a base material of the transparent light exit layer includes a flexible thermoplastic transparent resin;
the flexible thermoplastic transparent resin has a hardness lower than A100 and includes a flexible thermoplastic acrylic resin; and
the transparent light exit layer includes an antioxidant material and an ultraviolet absorbing material.

27. (canceled)

28. (canceled)

29. The linear light-emitting element according to claim 1, wherein a base material of the reflective layer includes a flexible thermoplastic transparent resin;
the flexible thermoplastic transparent resin has a hardness lower than A100 and includes a flexible thermoplastic acrylic resin.

30. (canceled)

31. The linear light-emitting element according to claim 1, wherein a base material of the reflective layer and a base material of the transparent light exit layer are the same;
the reflective layer includes an antioxidant material, an ultraviolet absorbing material, and a color powder and/or color masterbatch.

32. (canceled)

33. The linear light-emitting element according to claim 31, wherein the ultraviolet absorbing material includes at least one of low-volatile dimeric 2-hydroxybenzotriazole and hydroxyphenylbenzotriazole.

34. (canceled)

35. (canceled)

36. (canceled)
